(19) United States
(12) Patent Application Publication
(10) Pub. No.: US 2026/0112332 A1
(43) Pub. Date: Apr. 23, 2026

(54) DUAL-MODE TRANSMISSION DEVICE

(71) Applicant: Qisda Corporation, Taoyuan City (TW)

(72) Inventors: Wei-Yu CHEN, Taoyuan City (TW); Fu-Tsu YEN, Taoyuan City (TW); Chien-Szu CHIU, Taoyuan City (TW); Yu-Liang CHEN, Taoyuan City (TW)

(73) Assignee: Qisda Corporation, Taoyuan City (TW)

(21) Appl. No.: 19/245,574

(22) Filed: Jun. 23, 2025

(30) Foreign Application Priority Data
Oct. 23, 2024 (CN) 202411485414.8

(51) Int. Cl. G09G 5/00

(52) U.S. Cl. CPC G09G 5/006; G09G 5/005

(57) ABSTRACT

A dual-mode transmission device includes a dual-mode signal output port, a detection module and a signal mode switching module. The dual-mode signal output port is configured to switchably connect a data source to a DP signal receiving port or an HDMI signal receiving port. The detection module is configured for detecting the type of a signal receiving port connected to the dual-mode signal output port. The signal mode switching module converts the dual-mode signal output port into a DP specification signal output port according to the type of the signal receiving port, and connects to the DP signal receiving port accordingly; or converts the dual-mode signal output port into an HDMI specification signal output port, and connects to the HDMI signal receiving port. The signal mode switching module switches the DP and the HDMI specification signal output ports by detecting potentials of pins through the detection module.

This application claims the benefit of People Republic of China application Serial No. 202411485414.8, filed Oct. 23, 2024, the subject matter of which is incorporated herein by reference.

### BACKGROUND OF THE INVENTION

### Field of the Invention

The invention relates in general to a transmission device, and more particularly to a dual-mode transmission device.

### Description of the Related Art

Today's electronic products have increasingly higher requirements for the transmission of audio, video and file data, which also requires the continuous advancement of high-speed transmission interface technology. Traditional transmission interface technologies, such as Digital Visual Interface (DVI), Video Graphics Array (VGA), and Low Voltage Differential Signaling (LVDS), can no longer meet market demand. High Definition Multimedia Interface (HDMI) uses TMDS (Time Minimized Differential Signal) transmission technology to minimize differential signals. It has gradually replaced the traditional transmission architecture due to its advantages such as high transmission bandwidth, digital data protection and combined transmission of video and audio.

In addition, a typical display port (DP) interface technology uses low voltage differential signals and uses a packet technology similar to Ethernet and USB interfaces to packetize the transmitted data for transmission. In order to make the two different transmission interfaces, HDMI and DP, interconnect with each other, the industry has proposed a new interface that supports dual-mode transmission, called DP++ transmission interface. However, this DP++ transmission interface requires the use of additional converters and new cables to adjust the transmission format and convert the signal content. This not only requires additional equipment costs, but also the transmitted data is easily lost due to signal loss during conversion, resulting in distortion of display quality, etc., which adds inconvenience to the user's operation.

### SUMMARY OF THE INVENTION

The present invention relates to a dual-mode transmission device, which detects each potential of two pins of a dual-mode signal output port and outputs a data source as an HDMI specification signal or a DP specification signal through the dual-mode signal output port.

According to one aspect of the present invention, a dual-mode transmission device is provided. The dual-mode transmission device includes a dual-mode signal output port, a detection module, and a signal mode switching module. The dual-mode signal output port is configured to switchably connect a data source to a DP signal receiving port or an HDMI signal receiving port. The detection module is configured for detecting a type of a signal receiving port connected to the dual-mode signal output port. The signal mode switching module converts the dual-mode signal output port into a DP specification signal output port according to the type of the signal receiving port, and is connected to the DP signal receiving port correspondingly; or converts the dual-mode signal output port into an HDMI specification signal output port, and is connected to the HDMI signal receiving port correspondingly. The dual-mode signal output port, the detection module and the signal mode switching module are electrically connected to each other. The signal mode switching module switches the DP specification signal output port and the HDMI specification signal output port by detecting each potential of pins through the detection module.

In one embodiment of the present invention, the built-in detection module and signal mode switching module can detect the type of port for transmitting data through the dual-mode signal output port, and provide different transmission environments for different transmission data contents. There is no need to use additional converters, such as server keys, to adjust the transmission format and convert the signal content for the transmitted data. It not only saves equipment costs, but also avoids content distortion caused by signal loss during data conversion.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a system block diagram of a dual-mode transmission device, a data source, and a signal receiving device according to an embodiment of the present invention.

FIGS. 2A and 2B are pin mapping diagrams of a dual-mode signal output port according to an embodiment of the present invention.

FIG. 3 is a schematic diagram showing a detection module detecting potentials of two pins according to an embodiment of the present invention.

FIG. 4 is a schematic diagram illustrating a signal mode switching module using a control data signal switching circuit to convert a dual-mode signal output port into a DP specification signal output port according to an embodiment of the present invention.

FIG. 5 is a schematic diagram illustrating a signal mode switching module using a control data signal switching circuit to convert a dual-mode signal output port into an HDMI specification signal output port according to an embodiment of the present invention.

### DETAILED DESCRIPTION OF THE INVENTION

In order to make the above embodiments and other purposes, features and advantages of this disclosure more clearly understood, several preferred embodiments are specifically cited below and described in detail with reference to the accompanying drawings. However, it must be noted that these specific implementation and methods are not intended to limit the present invention. The present invention may still be implemented using other features, elements, methods and parameters. The preferred embodiments are only provided to illustrate the technical features of the present invention, and are not intended to limit the claims of the present invention. Those skilled in the art will be able to make equivalent modifications and changes based on the following description without departing from the spirit and scope of the present invention. In different embodiments and drawings, the same elements will be represented by the same reference numerals.

The present invention provides a dual-mode transmission device that can save device costs and avoid data distortion caused by signal loss during data conversion.

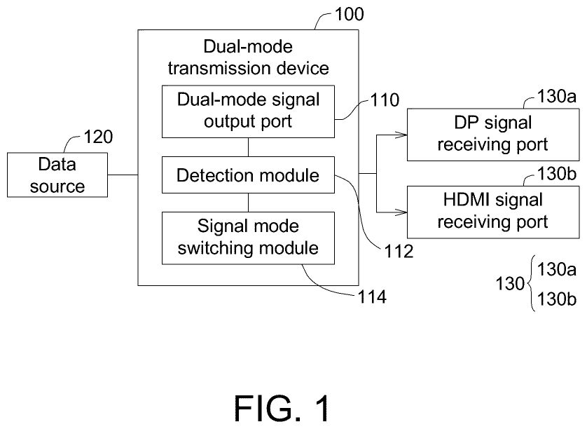

Referring to FIG. 1, a system block diagram of a dual-mode transmission device 100, a data source 120, and a signal receiving device 130 according to an embodiment of the present invention is provided. The dual-mode transmission device 100 includes a dual-mode signal output port 110, a detection module 112, and a signal mode switching module 114. The dual-mode transmission device 100 is configured to connect a data source 120 and a signal receiving device 130.

For example, in some embodiments of the disclosure, the dual-mode transmission device 100 can be a device connected between a data source 120 (such as a desktop computer, a DVD player, a notebook computer or a mobile phone) and a signal receiving device 130 (such as a display), and is configured to transmit audio and video signals provided by the data source 120 to the signal receiving device 130 for display and playback. The signal receiving device 130 may have a built-in data receiving port, such as a DP signal receiving port 130a or a HDMI signal receiving port 130b, according to the type of data to be played, such as a DP specification signal or an HDMI specification signal.

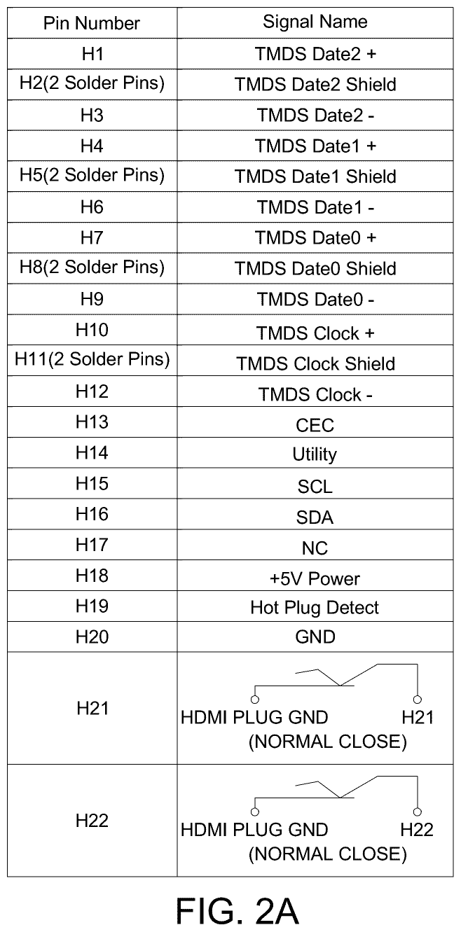

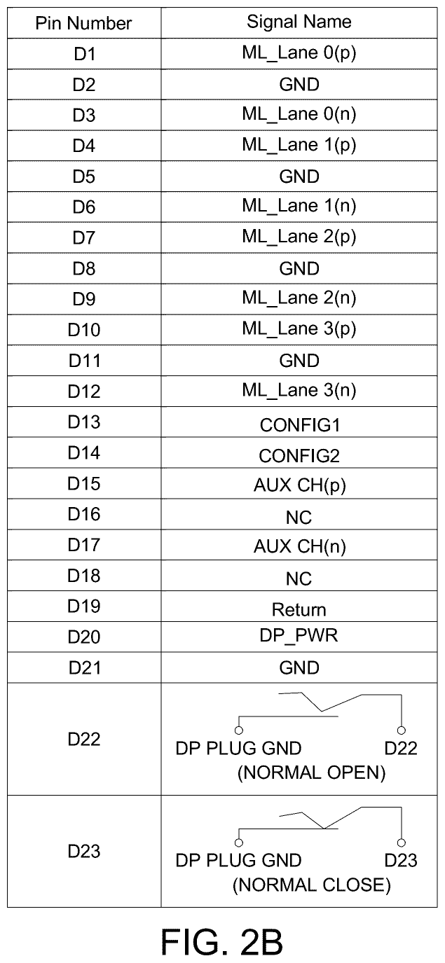

The dual-mode signal output port 110 is configured to switchably connect the data source 120 to the DP signal receiving port 130a or the HDMI signal receiving port 130b. Referring to FIG. 2A and FIG. 2B, pin mapping diagrams of the dual-mode signal output port 110 according to an embodiment of the present invention are shown. FIG. 2A illustrates the pin number and signal name of the dual-mode signal output port 110 when outputting HDMI signals, and FIG. 2B illustrates the pin number and signal name of the dual-mode signal output port 110 when outputting DP signals.

In some embodiments, the dual-mode signal output port 110 includes 22 HDMI pins and 23 DP pins. The HDMI pins and the DP pins can be shared. The pins H1 to H22 shown in FIG. 2A represent the pin definitions corresponding to HDMI specification signals. The pins D1 to D23 shown in FIG. 2B represent the pin definitions corresponding to the DP specification signals.

In some embodiments, pin H21 and pin D22 are located at the same pin position (hereinafter referred to as the first pin), and pin H22 and pin D23 are located at the same pin position (hereinafter referred to as the second pin). The two pins can be configured as two detection pins for the detection module 112.

The detection module 112 includes a detection circuit electrically connected to the dual-mode signal output port 110 and the signal mode switching module 114, and is configured to detect the type of the signal receiving port connected to the dual-mode signal output port 110 to determine whether it is the DP signal receiving port 130a or the HDMI signal receiving port 130b. In one embodiment, the detection module 112 may be connected to two pins of the dual-mode signal output port 110, wherein the first pin is H21/D22 and the second pin is H22/D23.

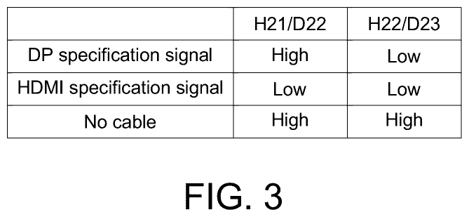

Referring to FIG. 3, a schematic diagram of the detection module 112 detecting each potential of two pins according to an embodiment of the present invention. For example, when the dual-mode signal output port 110 is connected to the DP signal receiving port 130a, the detection module 112 detects that the first pin D22 has a first potential (e.g., a high potential), and the detection module 112 detects that the second pin D23 has a second potential (e.g., a low potential), wherein the first potential is different from the second potential; or when the dual-mode signal output port 110 is connected to the HDMI signal receiving port 130b, the detection module 112 detects that the first pin H21 has a second potential (e.g., a low potential), and the detection module 112 detects that the second pin H22 has a second potential (e.g., a low potential), and outputs the detected result through the output end of the detection module 112.

In addition, when the dual-mode signal output port 110 is not connected to the DP signal receiving port 130a and the HDMI signal receiving port 130b, the detection module 112 detects that the first pin H21/D22 has a first potential (e.g., a high potential) and the second pin H22/D23 has a first potential (e.g., a high potential), and outputs the detected result through the output end of the detection module 112. Alternatively, in another embodiment, when the dual-mode signal output port 110 is not connected to the DP signal receiving port 130a and the HDMI signal receiving port 130b, the detection module 112 detects that the first pin H21/D22 has a second potential (e.g., a low potential) and the second pin H22/D23 has a first potential (e.g., a high potential), and outputs the detected result through the output end of the detection module 112, but the present invention is not limited thereto.

The signal mode switching module 114 includes a first peripheral switching circuit 115 and a second peripheral switching circuit 116, which are respectively connected between the data source 120 and the dual-mode signal output port 110 (as shown in FIG. 1). The signal mode switching module 114 can convert the dual-mode signal output port 110 into a DP specification signal output port according to the detection result output by the detection module 112, and connect to the DP signal receiving port 130a; or convert the dual-mode signal output port 110 into an HDMI specification signal output port, and connect to the HDMI signal receiving port 130b.

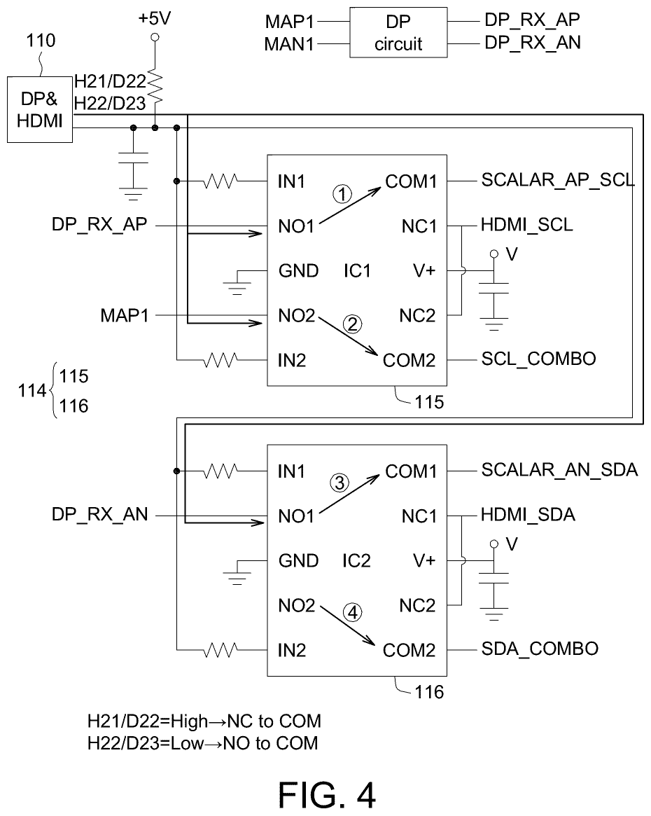

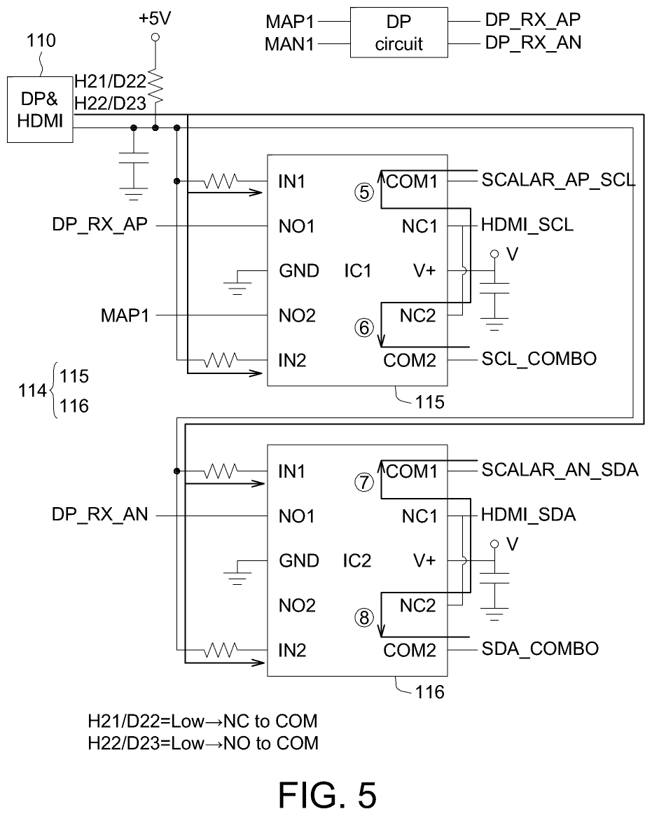

Referring to FIG. 4 and FIG. 5, FIG. 4 is a schematic diagram illustrating the signal mode switching module 114 uses a control data signal switching circuit to convert the dual-mode signal output port 110 into a DP specification signal output port according to an embodiment of the present invention. FIG. 5 is a schematic diagram illustrating the signal mode switching module 114, which uses a control data signal switching circuit to convert a dual-mode signal output port 110 into an HDMI specification signal output port according to an embodiment of the present invention. The first peripheral switching circuit 115 and the second peripheral switching circuit 116 may be integrated circuits, micro-controllers or programmable controllers, but the invention is not limited thereto.

The first peripheral switching circuit 115 includes a first data input port MAP1 and a second data input port DP_RX_AP. The first data input port MAP1 and the second data input port DP_RX_AP are connected between the data source 120 and a plurality of first data input pins of the dual-mode signal output port 110. The first peripheral switching circuit 115 is configured to transmit an HDMI specification signal or a DP specification signal according to the type of the signal receiving port to allow or prohibit the data source 120 transmitting the HDMI specification signal or the DP specification signal to the dual-mode signal output port 110.

The pin MAN1 of the DP circuit belongs to the 17th pin of the DP signal source. The second peripheral switching circuit 116 includes a third data input port DP_RX_AN. The third data input port DP_RX_AN is connected between the data source 120 and a plurality of second data input pins of the dual-mode signal output port 110. The second peripheral switching circuit 116 is configured to transmit another HDMI specification signal or another DP specification signal according to the type of the signal receiving port to allow or prohibit the data source 120 transmitting the another HDMI specification signal or the another DP specification signal to the dual-mode signal output port 110.

For example, when the detection module 112 detects that the first pin D22 has a first potential (e.g., a high potential) and the second pin D23 has a second potential (e.g., a low potential), the signal mode switching module 114 turns on the DP interface of the data source 120 and the 1st, 3rd, 4th, 6th, 7th, 9th, 10th, and 12th pins of the dual-mode signal output port 110 according to the type of the signal receiving port (e.g., DP type), so as to allow the data source 120 to transmit DP specification signals (e.g., data signals ML_Lane 0(p), ML_Lane 0(n), ML_Lane 1(p), ML_Lane 1(n), ML_Lane 2(p), ML_Lane 2(n), ML_Lane 3(p), and ML_Lane 3(n)) to the 1st, 3rd, 4th, 6th, 7th, 9th, 10th, and 12th pins of the dual-mode signal output port 110. At the same time, the signal mode switching module 114 can prohibit the data source 120 from transmitting HDMI specification signals (e.g., data signals TMDS Data2+, TMDS Data2−, TMDS Data1+, TMDS Data1−, TMDS Data0+, TMDS Data0−, TMDS Clock+, and TMDS Clock−) to the 1st, 3rd, 4th, 6th, 7th, 9th, 10th, and 12th pins of the dual-mode signal output port 110.

In addition, when the detection module 112 detects that the first pin H21 has a second potential (e.g., a low potential) and the second pin H22 has a second potential (e.g., a low potential), the signal mode switching module 114 turns on the HDMI interface of the data source 120 and the 1st, 3rd, 4th, 6th, 7th, 9th, 10th, and 12th pins of the dual-mode signal output port 110 according to the type of the signal receiving port (e.g., HDMI type), so as to allow the data source 120 to transmit HDMI specification signals (e.g., data signals TMDS Data2+, TMDS Data2−, TMDS Data1+, TMDS Data1−, TMDS Data0+, TMDS Data0−, TMDS Clock+, and TMDS Clock−) to the 1st, 3rd, 4th, 6th, 7th, 9th, 10th, and 12th pins of the dual-mode signal output port 110. At the same time, the signal mode switching module 114 can prohibit the data source 120 from transmitting DP specification signals (e.g., data signals ML_Lane 0(p), ML_Lane 0(n), ML_Lane 1(p), ML_Lane 1(n), ML_Lane 2(p), ML_Lane 2(n), ML_Lane 3(p), and ML_Lane 3(n)) to the 1st, 3rd, 4th, 6th, 7th, 9th, 10th, and 12th pins of the dual-mode signal output port 110.

Referring to FIG. 4, the first peripheral switching circuit 115 includes a first data output port SCL_COMBO and a second data output port SCALAR_AP_SCL. When the dual-mode signal output port 110 is connected to the DP signal receiving port 103a of the DP circuit, the first pin H21/D22 has a first potential (e.g., a high potential) and the second pin H22/D23 has a second potential (e.g., a low potential). The detection module 112 turns on a normally open switch NO1/NO2 of the first peripheral switching circuit 115 to a common end COM1/COM2 (as shown by lines \textcircled{1} and \textcircled{2}) , so that the first data input port MAP1 is electrically connected to the first data output port SCL_COMBO, and the second data input port DP_RX_AP is electrically connected to the second data output port SCALAR_AP_SCL, so as to transmit the AUX_CH(p) signal in the DP specification signal to the 15th pin of the dual-mode signal output port 110.

Referring to FIG. 4, the second peripheral switching circuit 116 includes a third data output port SDA_COMBO and a fourth data output port SCALAR_AN_SDA. When the dual-mode signal output port 110 is connected to the DP signal receiving port 103a of the DP circuit, the first pin H21/D22 has a first potential (e.g., a high potential), and the detection module 112 turns on a normally open switch (NO1/NO2) of the second peripheral switching circuit 116 to a common end COM1/COM2 (as shown by lines \textcircled{3} and \textcircled{4}) to disconnect the third data output port SDA_COMBO, and the third data input port DP_RX_AN is electrically connected to the fourth data output port SCALAR_AN_SDA to transmit the AUX_CH(n) signal in the DP specification signal to the 17th pin of the dual-mode signal output port 110.

As described above, since the dual-mode signal output port 110 has been converted into a DP specification signal output port, the DP specification data provided by the data source 120 can be transmitted to the signal receiving device 130 through the dual-mode signal output port 110 and the DP signal receiving port 130a.

Referring to FIG. 5, when the dual-mode signal output port 110 is connected to the HDMI signal receiving port 103B, the first pin H21/D22 has the second potential (e.g., a low potential) and the second pin H22/D23 also has the second potential (e.g., a low potential). The detection module 112 turns on a normally closed switch NC1/NC2 of the first peripheral switching circuit 115 to the common end COM1/COM2 (as shown by lines \textcircled{5} and \textcircled{6}) ), so that a signal output port HDMI_SCL connected to the normally closed switch NC1/NC2, the first data output port SCL_COMBO and the second data output port SCALAR_AP_SCL are electrically connected to transmit the SCL signal in the HDMI specification signal to the 15th pin of the dual-mode signal output port 110.

Referring to FIG. 5, when the dual-mode signal output port 110 is connected to the HDMI signal receiving port 103B, the detection module 112 turns on a normally closed switch NC1/NC2 of the first peripheral switching circuit 115 to the common end COM1/COM2 (as shown by lines \textcircled{7} and \textcircled{8}) , so that a signal output port HDMI_SDA connected to the normally closed switch NC1/NC2, the third data output port SDA_COMBO and the fourth data output port SCALAR_AN_SDA are electrically connected to transmit the SDA signal in the HDMI specification signal to the 16th pin of the dual-mode signal output port 110.

As described above, since the dual-mode signal output port 110 has been converted into an HDMI specification signal output port, the HDMI specification signal provided by the data source 120 can be transmitted to the signal receiving device 130 through the dual-mode signal output port 110 and the HDMI signal receiving port 130b.

In some embodiments, the detection module 112 determines the type of the signal receiving port connected to the dual-mode signal output port 110 by detecting each potential of the two pins of the dual-mode signal output port 110. When the detection module 112 detects that the first pin H21/D22 has the first potential and the second pin H22/D23 has the second potential, it is determined that the dual-mode signal output port 110 is connected to the DP signal receiving port 130a. When the detection module 112 detects that both of the first pin H21/D22 and the second pin H22/D23 have the second potential, it is determined that the dual-mode signal output port 110 is connected to the HDMI signal receiving port 130b.

It can be seen that the built-in detection module 112 and the signal mode switching module 114 can detect the type of port for transmitting data through the dual-mode signal output port 110, and provide different transmission environments for different transmission data contents. Therefore, there is no need to use an additional converter to adjust the transmission format and convert the signal content for the transmitted data. The dual-mode transmission device in the embodiments can not only save device cost, but also avoid the problem of data distortion caused by signal loss during data conversion.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A dual-mode transmission device, comprising:
a dual-mode signal output port for switchably connecting a data source to a DP signal receiving port or an HDMI signal receiving port;
a detection module, configured for detecting a type of a signal receiving port connected to the dual-mode signal output port; and
a signal mode switching module for converting the dual-mode signal output port into a DP specification signal output port according to the type of the signal receiving port, and being connected to the DP signal receiving port correspondingly; or converting the dual-mode signal output port into an HDMI specification signal output port, and being connected to the HDMI signal receiving port correspondingly,
wherein the dual-mode signal output port, the detection module and the signal mode switching module are electrically connected to each other, the signal mode switching module switches the DP specification signal output port and the HDMI specification signal output port by detecting potentials of pins through the detection module.

2. The dual-mode transmission device of claim 1, wherein the pins comprise a first pin and a second pin, which are respectively located in the dual-mode signal output port, and when the dual-mode signal output port is connected to the DP signal receiving port, the first pin has a first potential, and the second pin has a second potential, and the first potential is different from the second potential.

3. The dual-mode transmission device of claim 2, wherein when the dual-mode signal output port is connected to the HDMI signal receiving port, the first pin has the second potential, and the second pin has the second potential.

4. The dual-mode transmission device of claim 2, wherein when the dual-mode signal output port is not connected to the DP signal receiving port and the HDMI signal receiving port, the first pin has the first potential, and the second pin has the first potential.

5. The dual-mode transmission device of claim 2, wherein the first potential is a high potential and the second potential is a low potential.

6. The dual-mode transmission device of claim 2, wherein the signal mode
switching module comprises:
a first peripheral switching circuit, comprising a first data input port and a second data input port, wherein the first data input port and the second data input port connect the data source and a plurality of first data input pins of the dual-mode signal output port, and the first peripheral switching circuit is configured to transmit an HDMI specification signal or a DP specification signal according to the type of the signal receiving port, so as to allow or prohibit the data source transmitting the HDMI specification signal or the DP specification signal to the dual-mode signal output port; and
a second peripheral switching circuit, comprising a third data input port for connecting the data source and a plurality of second data input pins of the dual-mode signal output port, the second peripheral switching circuit is configured to transmit another HDMI specification signal or another DP specification signal according to the type of the signal receiving port, so as to allow or prohibit the data source transmitting the another HDMI specification signal or the another DP specification signal to the dual-mode signal output port.

7. The dual-mode transmission device of claim 6, wherein the first peripheral switching circuit further comprises a first data output port and a second data output port, and when the dual-mode signal output port is connected to the DP signal receiving port, the detection module turns on a normally open switch of the first peripheral switching circuit to a common end, so that the first data input port is electrically connected to the first data output port, and the second data input port is electrically connected to the second data output port, so as to transmit AUX_CH(p) signal in the DP specification signal.

8. The dual-mode transmission device of claim 7, wherein when the dual-mode signal output port is connected to the HDMI signal receiving port, the detection module turns on a normally closed switch of the first peripheral switching circuit to the common end, so that a signal output port connected to the normally closed switch, the first data output port and the second data output port are electrically connected to transmit SCL signal in the HDMI specification signal.

9. The dual-mode transmission device of claim 6, wherein the second peripheral switching circuit further comprises a third data output port and a fourth data output port, and when the dual-mode signal output port is connected to the DP signal receiving port, the detection module turns on a normally open switch of the second peripheral switching circuit to a common end to disconnect the third data output port, and the third data input port is electrically connected to the fourth data output port to transmit AUX_CH(n) signal in the DP specification signal.

10. The dual-mode transmission device of claim 9, wherein when the dual-mode signal output port is connected to the HDMI signal receiving port, the detection module turns on a normally closed switch of the first peripheral switching circuit to the common end, so that a signal output port connected to the normally closed switch, the third data output port and the fourth data output port are electrically connected to transmit SDA signal in the HDMI specification signal.

11. A dual-mode transmission device, comprising:
a signal mode switching module for converting the dual-mode signal output port into a DP specification signal output port or an HDMI specification signal output port by detecting potentials of pins, wherein the pins comprise a first pin and a second pin, which are respectively located in a dual-mode signal output port, wherein the dual-mode signal output port is for switchably connecting a data source to a DP signal receiving port or a HDMI signal receiving port,
when the dual-mode signal output port is connected to the DP signal receiving port, the first pin has a first potential, and the second pin has a second potential, and the first potential is different from the second potential,
when the dual-mode signal output port is connected to the HDMI signal receiving port, the first pin has the second potential, and the second pin has the second potential.

12. The dual-mode transmission device of claim 11, further comprising:
a detection module configured for detecting a type of a signal receiving port connected to the dual-mode signal output port through the two pins.

13. The dual-mode transmission device of claim 11, wherein the data source serves as an HDMI specification signal or a DP specification signal through the dual-mode signal output port.

14. The dual-mode transmission device of claim 11, wherein when the dual-mode signal output port is not connected to the DP signal receiving port and the HDMI signal receiving port, the first pin has the first potential, and the second pin has the first potential.

15. The dual-mode transmission device of claim 11, wherein the first potential is a high potential and the second potential is a low potential.

16. The dual-mode transmission device of claim 12, wherein the signal mode
switching module comprises:
a first peripheral switching circuit, comprising a first data input port and a second data input port, wherein the first data input port and the second data input port connect the data source and a plurality of first data input pins of the dual-mode signal output port, and the first peripheral switching circuit is configured to transmit an HDMI specification signal or a DP specification signal according to the type of the signal receiving port, so as to allow or prohibit the data source transmitting the HDMI specification signal or the DP specification signal to the dual-mode signal output port; and
a second peripheral switching circuit, comprising a third data input port for connecting the data source and a plurality of second data input pins of the dual-mode signal output port, the second peripheral switching circuit is configured to transmit another HDMI specification signal or another DP specification signal according to the type of the signal receiving port, so as to allow or prohibit the data source transmitting the another HDMI specification signal or the another DP specification signal to the dual-mode signal output port.

17. The dual-mode transmission device of claim 16, wherein the first peripheral switching circuit further comprises a first data output port and a second data output port, and when the dual-mode signal output port is connected to the DP signal receiving port, the detection module turns on a normally open switch of the first peripheral switching circuit to a common end, so that the first data input port is electrically connected to the first data output port, and the second data input port is electrically connected to the second data output port, so as to transmit AUX_CH(p) signal in the DP specification signal.

18. The dual-mode transmission device of claim 17, wherein when the dual-mode signal output port is connected to the HDMI signal receiving port, the detection module turns on a normally closed switch of the first peripheral switching circuit to the common end, so that a signal output port connected to the normally closed switch, the first data output port and the second data output port are electrically connected to transmit SCL signal in the HDMI specification signal.

19. The dual-mode transmission device of claim 16, wherein the second peripheral switching circuit further comprises a third data output port and a fourth data output port, and when the dual-mode signal output port is connected to the DP signal receiving port, the detection module turns on a normally open switch of the second peripheral switching circuit to a common end to disconnect the third data output port, and the third data input port is electrically connected to the fourth data output port to transmit AUX_CH(n) signal in the DP specification signal.

20. The dual-mode transmission device of claim 19, wherein when the dual-mode signal output port is connected to the HDMI signal receiving port, the detection module turns on a normally closed switch of the first peripheral switching circuit to the common end, so that a signal output port connected to the normally closed switch, the third data output port and the fourth data output port are electrically connected to transmit SDA signal in the HDMI specification signal.
